(19) United States
(12) Patent Application Publication
(10) Pub. No.: US 2006/0161794 A1
(43) Pub. Date: Jul. 20, 2006

(54) Prioritizing power throttling in an information handling system

(75) Inventors: Shane Chiasson, Pflugerville, TX (US); Sompong Paul Olarig, Pleasanton, CA (US)

Correspondence Address: BAKER BOTTS, LLP, 910 LOUISIANA, HOUSTON, TX, 77002-4995, US

(73) Assignee: Dell Products L.P.

(21) Appl. No.: 11/037,555

(22) Filed: Jan. 18, 2005

(51) Int. Cl. G06F 1/26

(52) U.S. Cl. 713/300

(57) ABSTRACT

Prioritization of power throttling of servers in an information handling system may be based upon slot or location priority, subscription priority, and/or greatest power usage. A power system having a capacity of less than the maximum connected power load is monitored to determine the power being drawn therefrom. When the power drawn from the power supply system exceeds a first threshold, power throttling requests are issued to the appropriate servers until the power drawn from the power supply is less than a second threshold. The second threshold less than the first threshold. The appropriate servers may be configurable e.g., determined by a configurable prioritization schedule.

### BACKGROUND OF THE INVENTION TECHNOLOGY

1. Field of the Invention

The present disclosure relates generally to information handling systems and, more particularly, to a system and method of prioritizing power throttling of subsystems in the information handling system.

2. Description of the Related Art

As the value and use of information continues to increase, individuals and businesses seek additional ways to process and store information. One option available to users are information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems, e.g., computer, personal computer workstation, portable computer, computer server, print server, network router, network hub, network switch, storage area network disk array, RAID disk system and telecommunications switch.

An information handling system is powered from a power supply system that receives and converts alternating current (AC) power to direct current (DC) power at utilization voltages required by the electronic modules comprising the information handling system. The power supply system tightly regulates these utilization voltages and incorporates over current protection for each of the voltages. To further provide increased reliability of the power supply system, a plurality of power supply units (PSU) may be provided and coupled in parallel so that the loss or malfunction of one or more of the PSUs will not totally disable operation of the information handling system.

As consumer demand increases for smaller and denser information handling systems, manufacturers strive to integrate more computer components into a smaller space. This integration has led to the development of several applications, including high density servers. A high density server provides the computer processing resources of several computers in a small amount of space. A typical arrangement for a high density server includes a shared power supply system, a management module, a connection board (e.g., a back-plane or mid-plane) and server modules, such as blade server modules.

Blade server modules, or “blades,” are miniaturized server modules that typically are powered from a common power supply system and are cooled by cooling system within a multi-server cabinet. Typically, a blade includes a circuit board with one or more processors, memory, a connection port, and possibly a disk drive for storage. By arranging a plurality of blades like books on a shelf in the multi-server cabinet, a high density multi-server system achieves significant cost and space savings over a plurality of conventional servers. These savings result directly from the sharing of common resources (e.g., power supplies, cooling systems, enclosures, etc.,) and the reduction of space required by this type of multi-server system while providing a significant increase in available computer processing power.

Each generation of server has increased power requirements. These ever increasing power requirements are pushing cost effective design limits for multi-server systems that contain a power supply system adequate to power the plurality of servers comprising the multi-server system. Common power supplies are reaching or exceeding their maximum level of providing power. In some servers, the power requirements for a fully configured system may exceed the available power capacity of the shared power supply system. Typically, an under-capacity power supply system may have been used to save money or to prevent dangerous and excessive power density levels from being placed into a single multi-server system. However, using under-designed shared power supply systems leaves the multi-server system susceptible to the power supply system being over-subscribed and shutting down, resulting in the shutdown of the entire multi-server system.

### SUMMARY OF THE INVENTION

Therefore, there is a need for preventing the shutdown of an entire multi-server system due to an associated power supply system being over-subscribed. To prevent the entire multi-server system from shutting down due to the associated power supply system being over-subscribed, a throttling mechanism must be implemented to restrict the multi-server system peak power demands. However, the throttling mechanism must not cause problems for servers running critical applications.

The present invention remedies the shortcomings of the prior art by providing a system, method and apparatus for an information handling system, e.g., a multi-server system, that comprises a power supply system which identifies itself as a power supply system that has a power capacity lower (e.g., under-designed power supply system) than the theoretical maximum power requirements of the connected information handling system (e.g., multi-server system). The output power of the power supply system may be monitored as a percentage of the total available power capacity therefrom. A first power threshold may be user configurable so that when the power output exceeds the first power threshold, at least one of the servers in the information handling system may be requested (e.g., software instruction and/or hardware signal) to throttle back power usage. Server management software may generate a warning indicating that a power throttling request has been triggered. A power throttling software routine may, for example, request power throttling of a blade server having the highest slot number or having the lowest priority. Power throttling may occur in a server by suspending computational activities, reducing processor clock speed and/or voltage to the processor(s) of the server (e.g., software and/or hardware controllable). The priority for power throttling of each server may be user configurable, e.g., based upon server priority, user service subscription status, highest power consumption, etc. Power throttling may remain in effect until power drops below a second power threshold that may be lower than the first power threshold (e.g., hysteresis). The second power threshold may also be user configurable.

A technical advantage of the present invention is use of lower capacity power supplies for powering a plurality of servers. Still another technical advantage is configurable power throttling requests e.g., according to a user defined priority schedule. Yet another technical advantage is power throttling requests of lowest priority server power loads. Another technical advantage is power throttling requests according to a user service subscription. Another technical advantage is power throttling requests of the highest power server(s). Other technical advantages should be apparent to one of ordinary skill in the art in view of what has been disclosed herein.

### BRIEF DESCRIPTION OF THE DRAWINGS

A more complete understanding of the present disclosure and advantages thereof may be acquired by referring to the following description taken in conjunction with the accompanying drawings wherein:

FIG. 1 is a schematic perspective view of an example embodiment of a high density server system, according to teachings of the present disclosure;

FIG. 2 is a schematic block diagram of a server system having a power throttling feature, according to teachings of the present disclosure; and

FIGS. 3 and 4 are flowcharts for prioritizing power throttling of the server system, according to teachings of the present disclosure.

The present invention may be susceptible to various modifications and alternative forms. Specific exemplary embodiments thereof are shown by way of example in the drawing and are described herein in detail. It should be understood, however, that the description set forth herein of specific embodiments is not intended to limit the present invention to the particular forms disclosed. Rather, all modifications, alternatives, and equivalents falling within the spirit and scope of the invention as defined by the appended claims are intended to be covered.

### DETAILED DESCRIPTION OF SPECIFIC EMBODIMENTS

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU), hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring now to the drawings, the details of specific exemplary embodiments of the present invention are schematically illustrated. Like elements in the drawings will be represented by like numbers, and similar elements will be represented by like numbers with a different lower case letter suffix.

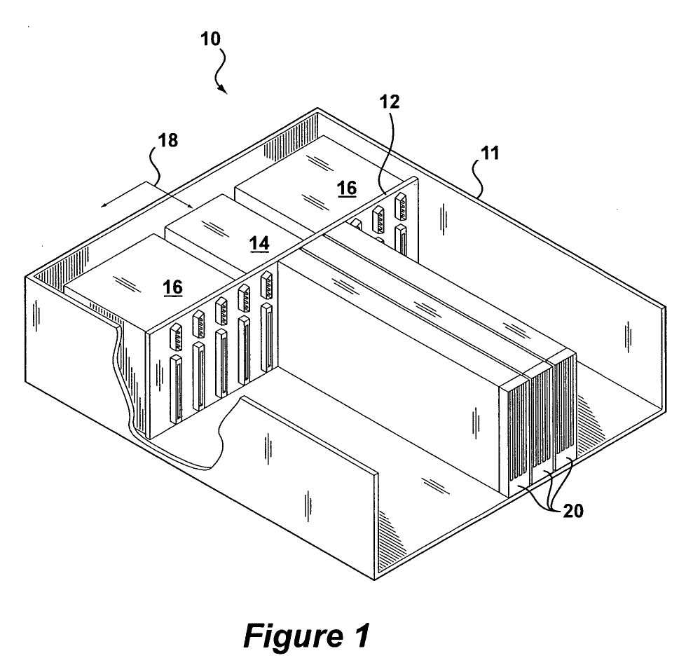

Referring now to FIG. 1, depicted is a perspective view of an exemplary embodiment of an information handling system, generally represented by the numeral 10. The information handling system 10 comprises at least one server module (blade) or server 20, a mid-plane 12, at least one power supply 16 and a power management module 14. In certain embodiments, one example of an information handling system 10 includes a high density server system 10 that may form a part of a component rack system (not expressly shown). Typically, the high density server system 10 includes an enclosure or chassis 11 in which the at least one power supply 16, management module 14, mid-plane 12, and at the least one server module 20 are enclosed.

Although FIG. 1 depicts mid-plane 12 as being placed between management module 14 and the at least one server module 20, mid-plane 12 may be located anywhere in server system 10, even external to the chassis 11. In alternate embodiments, mid-plane 12 may be located along the back of server system 10 and may be referred to as a back-plane (not shown).

The high density server system 10 may be coupled to other computer components such as keyboards, video displays and pointing devices (not expressly shown) using management module 14 via a connection 18. Typically, the management module 14 may control the connectivity of the at least one server module 20 of the server system 10. In one instance, connection 18 may couple a keyboard, video and mouse (KVM) to the management module 14 such that management module enables communications and control signals between the at least one server module 20 and other computer system modules (not expressly shown). Generally, management module 14 may be coupled to the mid-plane 12, such as for example, on an opposite side of the mid-plane 12 from the at least one server module 20. In another embodiment, the management module 14 may be placed external to the server system 10 for control of the at least one server module 20.

Typically, server system 10 may include more than one power supply 16 such that a redundant power source may be provided. The power supply 16 supplies a power supply output, e.g., an electrical voltage(s) to each server module 20. Generally, the power supply output (described below in more detail) connects through mid-plane 12 for distribution to each of the at least one server modules 20.

In one specific embodiment, the server module 20 comprises a blade server 20. Each blade server 20 may include a circuit board with one or more processors, memory, a connection port, and possibly a disk drive for storage (not shown). Depending on the size of server system 10, one or more server blades 20 may be connected to server system 10 such that power is provided by power supply 16 via mid-plane 12. The output to each server blade 20 may be controlled or throttled based on priority of a particular server module 20 such that the power drawn by the server blades 20 does not exceed the available power from the power supply 16.

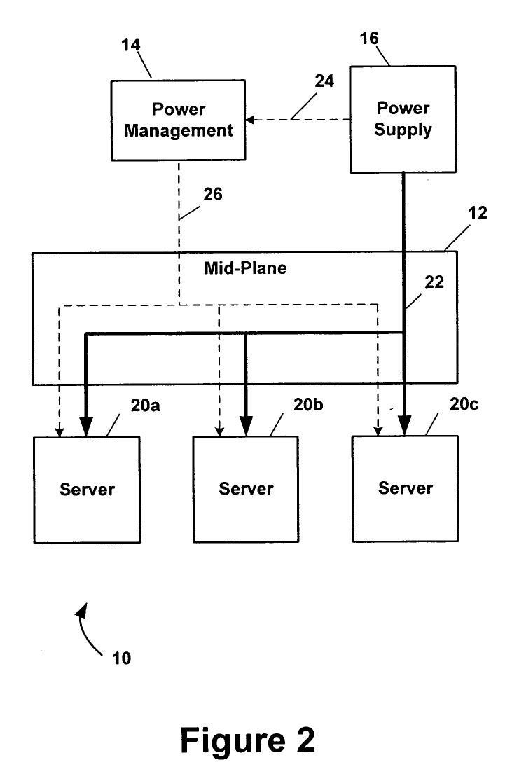

Referring to FIG. 2, depicted is a schematic block diagram of a server system having a power throttling feature, according to teachings of the present disclosure. Server system 10 preferably includes at least one power supply 16 for providing electrical power to server modules 20 via electrical power connection 22, e.g., a power bus 22 via the mid-plane 12; power management module 14, and a plurality of servers 20. When a power utilization threshold is exceeded in the at least one power supply 16, an alarm signal may be send on signal line 24 to the power management module 14. The power management module 14 may then determine a priority profile for requesting a specific server or servers 20 to begin throttling back power consumption. This profile may be configurable, e.g., user defined. Power throttling signals may be sent to the appropriate servers 20 over a power throttling bus 26. Once a server 20 receives a power throttling request, a number of different options are available that the requested server 20 may perform to reduce its power consumption. For example, but not limited to, suspending computational operations, lowering clock speed(s) and/or reducing processor operating voltage(s), and/or suspending disk and/or memory accessing. The range of power reduction options possible with each of the servers 20 may be user configurable. It is contemplated and within the scope of the present invention that more than one power supply 16 may be coupled to the power bus 22, and each power supply 16 having an alarm signal sent to the power management module 14 on an alarm signal line 24. The power management module 14 may be determine the power alarm condition by knowing the capacity of the power supply 20 and when monitoring the power supplied to the servers 20, the power management module may then determine the maximum available power capacity of the power supply 16.

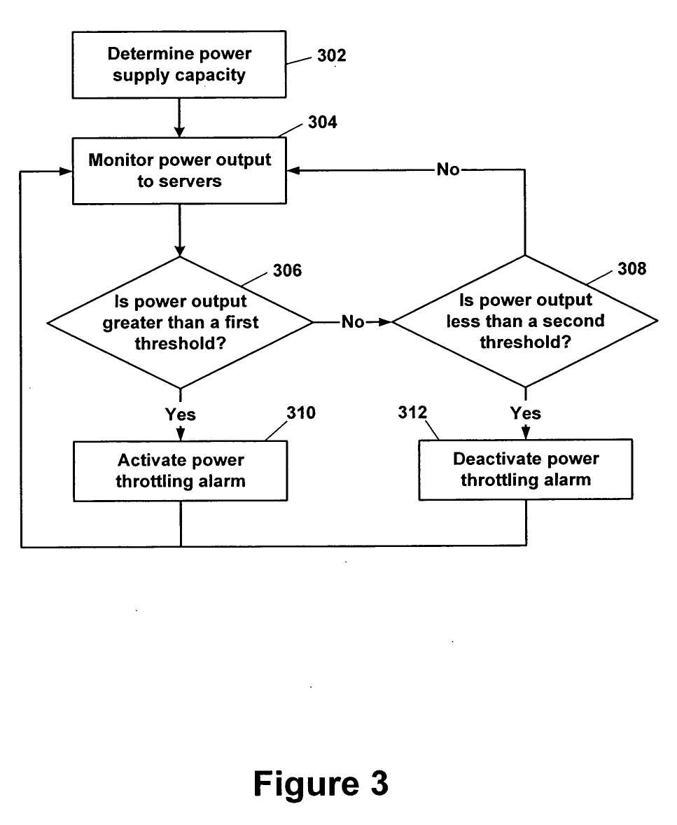

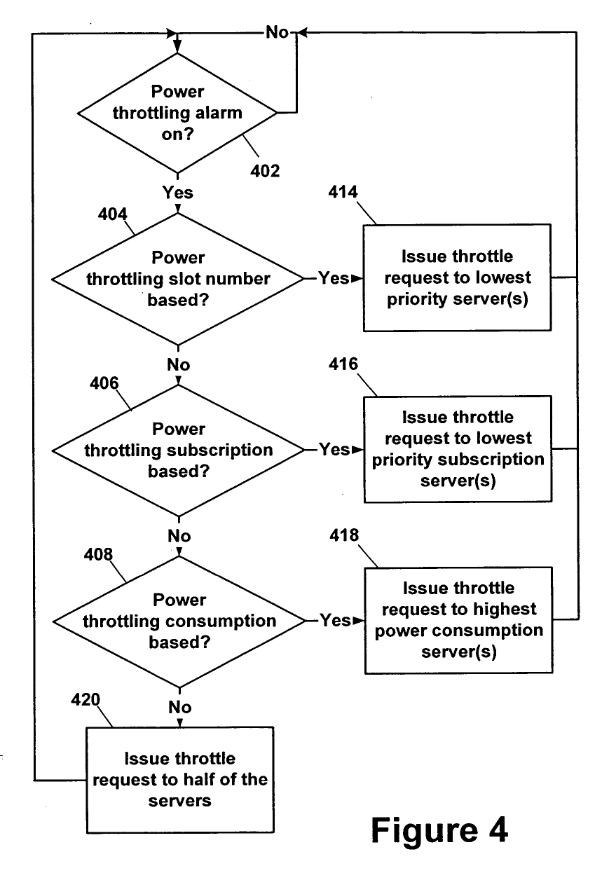

Referring now to FIGS. 3 and 4, depicted are flowcharts for prioritizing power supply throttling of the server system, according to teachings of the present disclosure. In step 302 the capacity of the power supply 16 is determined (or an alarm signal sent from the power supply 16). Then in step 304 the power drawn by the servers 20 (power output) may be monitored. In step 306, the monitored power output is compared to a first threshold. The first threshold may be configurable, e.g., user defined. If the first threshold of step 306 is exceeded, then step 310 will activate a power throttling alarm. Step 304 continuously monitors the power output (power drawn by the servers 20). If the monitored power output is not greater than the first threshold, then in step 308 the power output is compared to a second threshold and if the power output is less than the second threshold, then in step 312 the power throttling alarm is deactivated. The second threshold may also be configurable, e.g., user defined.

Referring to FIG. 4, once the power throttling alarm is activated, as determined in step 402, a selection of possible power throttling request options are examined and implemented. These throttling request options may be configurable, e.g., user defined. One possible option determined in step 404 is power throttling based upon slot or location of the server(s) 20, and when this option is desired, step 414 sends a throttle request to the lowest priority slot or location server(s) 20. Another possible option determined in step 406 is power throttling based upon subscription priority or seniority of the servers 20, and when this option is desired, step 416 sends a throttle request to the lowest subscription priority or seniority slot or location server(s) 20. Still another possible option determined in step 418 is power throttling based upon power consumption of the server(s) 20, and when this option is desired, step 418 sends a throttle request to the server(s) 20 having the greatest power consumption. If power throttling is still required, then step 420 may request for example, but not limited to, half of the servers 20 to reduce power consumption.

The invention, therefore, is well adapted to carry out the objects and to attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A method of prioritizing power throttling in an information handling system, said method comprising the steps of:
determining power capacity of a power supply system;
monitoring power supply system output to a plurality of servers in the information handling system;
activating a power throttling alarm when the power supply system output is greater than a first power threshold; and
issuing a power throttling request to at least one of the plurality of servers when the power throttling alarm is activated.

2. The method according to claim 1, wherein the power throttling request is prioritized based upon selecting lowest priority slot numbers of the plurality of servers.

3. The method according to claim 1, wherein the power throttling request is prioritized based upon selecting lowest priority subscriptions of the plurality of servers.

4. The method according to claim 1, wherein the power throttling request is prioritized based upon selecting highest power consumption servers of the plurality of servers.

5. The method according to claim 1, further comprising the step of deactivating the power throttling alarm when the power supply output is less than a second power threshold.

6. The method according to claim 1, wherein the first power threshold is configurable.

7. The method according to claim 5, wherein the second power threshold is configurable.

8. The method according to claim 2, wherein the slot number priorities are configurable.

9. The method according to claim 3, wherein the subscription priorities are configurable.

10. The method according to claim 1, wherein the power throttling request to the at least one of the plurality of servers is configurable.

11. An information handling system, comprising:
a midplane having a power distribution system;
at least one server coupled to the midplane power distribution system;
a power supply coupled to the midplane power distribution system, wherein the power supply provides power to the at least one server; and
a power management module, wherein the power management module measures an output of the power supply and requests the at least one server to reduce power usage when the power supply output exceeds a power threshold.

12. The information handling system according to claim 11, wherein power management module requests the at least one server to reduce power usage based upon a prioritization schedule.

13. The information handling system according to claim 12, wherein the prioritization schedule is configurable.

14. The information handling system according to claim 11, wherein the power supply has a power rating lower than a maximum theoretical power requirement of the at least one server.

15. The information handling system according to claim 11, wherein the at least one server comprises at least one blade server.

16. The information handling system according to claim 11, further comprising an enclosure for the midplane, the at least one server and the power supply.

17. The information handling system according to claim 11, wherein the power supply comprises a plurality of power supplies.

18. The information handling system according to claim 12, wherein the prioritization schedule is selected from the group consisting of lowest priority server slot number, lowest priority server subscriptions, and highest power consumption servers.

19. The information handling system according to claim 12, wherein the power threshold is configurable.

20. An apparatus for prioritizing power throttling in an information handling system having a power supply and at least one server coupled to the power supply, said apparatus comprising:
a power management module adapted to measure an output of the power supply and request the at least one server to reduce power usage when the power supply output exceeds a power threshold.

21. An apparatus according to claim 20, wherein the power threshold is configurable.

22. An apparatus according to claim 20, wherein the power throttling prioritization is selected from the group consisting of lowest priority server slot number, lowest priority server subscriptions, and highest power consumption servers.
